(19) United States
(12) Patent Application Publication
(10) Pub. No.: US 2024/0425124 A1
(43) Pub. Date: Dec. 26, 2024

(54) Remote-Control Wagon Device

(71) Applicant: Ebony Thompson, Desert Hot Springs, CA (US)

(72) Inventor: Ebony Thompson, Desert Hot Springs, CA (US)

(21) Appl. No.: 18/746,102

(22) Filed: Jun. 18, 2024

Related U.S. Application Data
(60) Provisional application No. 63/509,394, filed on Jun. 21, 2023.

(51) Int. Cl. B62D 51/00; B60C 5/00; B62D 1/28; B62D 29/04; B62D 63/04; F25D 11/00

(52) U.S. Cl. CPC B62D 51/005; B60C 5/00; B62D 1/283; B62D 29/043; B62D 63/04; B60C 2200/14; F25D 11/003

(57) ABSTRACT

The present invention relates to a remote-control wagon device designed for beach travel. The device is comprised of a foldable wagon that is self-propelled via a motor. The power of the motor and the direction of the device can be controlled wirelessly via a remote. The device is optimized for beach travel and has a plurality of areas and attachments to store items.

### CROSS-REFERENCE TO RELATED APPLICATION

The present application claims priority to, and the benefit of, U.S. Provisional Application No. 63/509,394, which was filed on Jun. 21, 2023, and is incorporated herein by reference in its entirety.

### FIELD OF THE INVENTION

The present invention relates generally to the field of wagons. More specifically, the present invention relates to a remote-control wagon device that is self-propelled via a motor that can be controlled wirelessly via a remote. The device is optimized for beach travel and has a plurality of areas and attachments to store items. Accordingly, the present disclosure makes specific reference thereto. Nonetheless, it is to be appreciated that aspects of the present invention are also equally applicable to other like applications, devices, and methods of manufacture.

### BACKGROUND

Carrying multiple items to or from the beach often requires multiple trips to a vehicle. In addition, carrying items such as beach towels, toys, coolers, etc., for individuals who lack the necessary strength can be difficult. As a result, many individuals may transport said items in a wagon. However, a wagon full of several beach items can become extremely heavy and very difficult to pull through beach sand. In addition, said wagons are often difficult to transport in a vehicle due to their large size. Furthermore, a user must unpack the wagon once they have reached their desired spot on the beach. However, many items within the wagon have no particular place they can be stored outside of the wagon.

Therefore, there exists a long-felt need in the art for an improved wagon. More specifically, there exists a long-felt need in the art for a remote-control wagon device that is optimized for beach use. There also exists a long-felt need in the art for a remote-control wagon device that is self-propelled such that it does not require a user to pull the device. In addition, there exists a long-felt need in the art for a remote-control wagon device that can be easily transported within a vehicle. Further, there exists a long-felt need in the art for a remote-control wagon device that provides areas to store beach supplies once a user has reached their beach destination.

The subject matter disclosed and claimed herein, in one embodiment thereof, comprises a remote-control wagon device. The device is primarily comprised of a body with a frame, at least one wheel, at least one sidewall, at least one motor, at least one battery, and at least one remote. The device is self-propelled via the motor and can be steered wirelessly via the remote. The sidewall of the device folds during transport to allow the device to be easily stored within a vehicle. In addition, the sidewall may be comprised of a hook, a rail, a pocket, etc., to allow a user to store various items on the device once they have reached their destination. In addition, the wheels of the device are optimized for traveling over sand.

In this manner, the remote-control wagon device of the present invention accomplishes all the foregoing objectives and provides a remote-control wagon device that is optimized for beach use and that is self-propelled such that it does not require a user to pull the device. In addition, the folding sidewalls of the device allow the device to be easily transported within a vehicle. Further, hooks, rails, and pockets provide areas to store beach supplies once a user has reached their beach destination.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a remote-control wagon device. The device is primarily comprised of a body with a frame, at least one wheel, at least one sidewall, at least one motor, at least one battery, and at least one remote. The body is attached to the frame which provides structural support to the body. The frame is comprised of at least one (but preferably two) axle, each with at least one (but preferably two) wheel. The wheel is preferably an inflatable wheel designed to travel over sand such that the device can be used at a beach.

The body is formed by four sidewalls. In one embodiment, each sidewall preferably attaches to the frame via at least one pivot point such as, but not limited to, a locking hinge. This allows each sidewall to fold at least 180 degrees around the hinge when not in use to allow the device to be easily stored in a vehicle to transport the device. Each sidewall may be secured to each other when in an unfolded configuration (i.e., a usable configuration) via at least one fastener such as, but not limited to, a locking fastener. The sidewalls may be comprised of various storage structures such as, but not limited to, a hook, a rail, or a pocket. The sidewalls form an interior space of the body that allows items to be stored in the body and be transported by the device.

The device is self-propelled via at least one motor. The motor is also comprised of at least one wireless receiver which is in wireless electrical communication with at least one transmitter of at least one remote. The remote is used to control the speed, power, and direction of the device using at least one button. During use, the motor may turn each axle simultaneously or independently to steer the device. The motor may also turn at least one drive shaft connected to each axle to propel each axle and wheel.

The present invention is also comprised of a method of using the device. First, a device is provided comprised of a body with a frame, at least one wheel, at least one sidewall, at least one motor, at least one battery, and at least one remote. Then, the device can be transported to an area with the sidewalls folded, wherein once a user reaches said area, the device can be removed from the transportation vehicle and the walls of the body can be unfolded and secured in an upright configuration using a fastener. Next, items can be placed into the interior space of the body and the device can be propelled and steered by the remote.

Accordingly, the remote-control wagon device of the present invention is particularly advantageous as it provides a remote-control wagon device that is optimized for beach use and that is self-propelled such that it does not require a user to pull the device. In addition, the folding sidewalls of the device allow the device to be easily transported within a vehicle. Further, hooks, rails, and pockets provide areas to store beach supplies once a user has reached their beach destination. In this manner, the remote-control wagon device overcomes the limitations of existing wagons known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a remote-control wagon device of the present invention in accordance with the disclosed architecture;

FIG. 2 illustrates a front view of one potential embodiment of a remote-control wagon device of the present invention in accordance with the disclosed architecture;

FIG. 3 illustrates a perspective view of one potential embodiment of a remote-control wagon device of the present invention in accordance with the disclosed architecture;

FIG. 4 illustrates a front view of a remote of one potential embodiment of a remote-control wagon device of the present invention in accordance with the disclosed architecture; and

FIG. 5 illustrates a flowchart of a method of using one potential embodiment of a remote-control wagon device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved wagon. More specifically, there exists a long-felt need in the art for a remote-control wagon device that is optimized for beach use. There also exists a long-felt need in the art for a remote-control wagon device that is self-propelled such that it does not require a user to pull the device. In addition, there exists a long-felt need in the art for a remote-control wagon device that can be easily transported within a vehicle. Further, there exists a long-felt need in the art for a remote-control wagon device that provides areas to store beach supplies once a user has reached their beach destination.

The present invention, in one exemplary embodiment, is comprised of a remote-control wagon device primarily comprised of a body with a frame, at least one wheel, at least one sidewall, at least one motor, at least one battery, and at least one remote. The body is attached to the frame which provides structural support to the body. The frame is comprised of at least one (but preferably two) axle, each with at least one (but preferably two) wheel. The wheel is preferably an inflatable wheel designed to travel over sand such that the device can be used at a beach.

The body is formed by four sidewalls. In one embodiment, each sidewall preferably attaches to the frame via at least one pivot point such as, but not limited to, a locking hinge to allow each sidewall to fold at least 180 degrees around the hinge when not in use to allow the device to be easily stored in a vehicle to transport the device. Each sidewall may be secured to each other when in an unfolded configuration (i.e., a usable configuration) via at least one fastener such as, but not limited to, a locking fastener. The sidewalls may be comprised of various storage structures such as, but not limited to, a hook, a rail, or a pocket. In addition, sidewalls form an interior space of the body that allow items to be stored in the body and be transported by the device.

The device is self-propelled via at least one motor comprised of at least one wireless receiver which is in wireless electrical communication with at least one transmitter of at least one remote. The remote is used to control the speed, power, and direction of the device using at least one button. During use, the motor may turn each axle simultaneously or independently to steer the device. The motor may also turn at least one drive shaft connected to each axle to propel each axle and wheel.

The present invention is also comprised of a method of using the device wherein a device is provided comprised of a body with a frame, at least one wheel, at least one sidewall, at least one motor, at least one battery, and at least one remote. Then, the device can be transported to an area with the sidewalls folded, wherein once a user reaches said area, the device can be removed from the transportation vehicle and the walls of the body can be unfolded and secured in an upright configuration using a fastener. Next, items can be placed into the interior space of the body and the device can be propelled and steered by the remote.

Accordingly, the remote-control wagon device of the present invention is particularly advantageous as it provides a remote-control wagon device that is optimized for beach use and that is self-propelled, such that it does not require a user to pull the device. In addition, the folding sidewalls of the device allow the device to be easily transported within a vehicle. Further, hooks, rails, and pockets provide areas to store beach supplies once a user has reached their beach destination. In this manner, the remote-control wagon device overcomes the limitations of existing wagons known in the art.

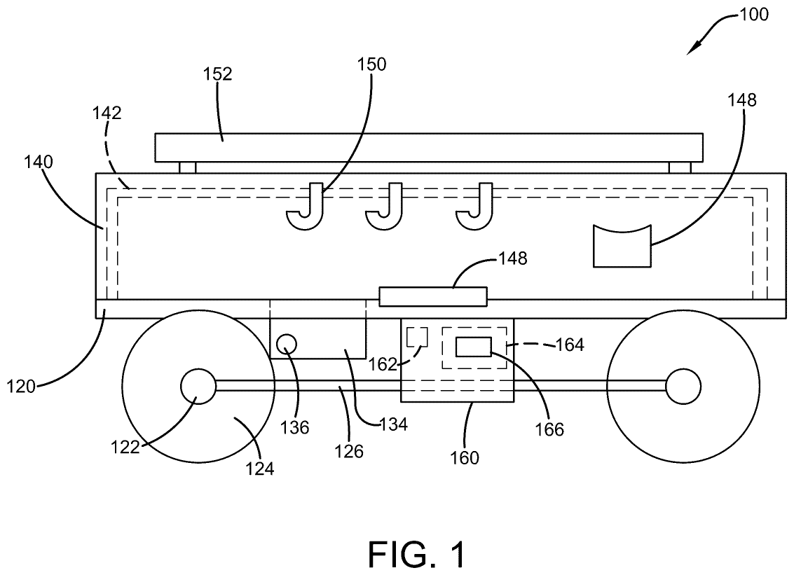

Referring initially to the drawings, FIG. 1 illustrates a side view of one potential embodiment of a remote-control wagon device 100 of the present invention in accordance with the disclosed architecture. The device 100 is primarily comprised of a body 110 with a frame 120, at least one wheel 124, at least one sidewall 140, at least one motor 160, at least one battery 164, and at least one remote 170. The body 110 is preferably rectangular in shape but may be any shape and size known in the art.

The body 110 may be fixedly or removably attached to the frame 120. The frame 120 is preferably made from a lightweight metal material or a rigid plastic material. The frame 120 provides structural support to the body 110. The frame 120 is comprised of at least one (but preferably two) axle 122, each with at least one (but preferably two) wheel 124. The wheel 124 may be any type of wheel such as, but not limited to, a run-flat wheel, an inflatable wheel, etc. However, the wheel 124 is preferably an inflatable wheel designed to travel over sand, such that the device 100 can be used at a beach.

The body 110 is formed by four sidewalls 140. The sidewalls 140 may be made from a lightweight plastic material that is waterproof. In another embodiment, the sidewalls 140 are comprised of a waterproof fabric material with an internal plastic frame 142 for structural support. In either embodiment, each sidewall 140 preferably attaches to the frame 120 via at least one pivot point 144 such as, but not limited to, a locking hinge. This allows each sidewall 140 to fold at least 180 degrees around the hinge when not in use to allow the device 100 to be easily stored in a vehicle to transport the device 100. Each sidewall 140 may be secured to each other when in an unfolded configuration (i.e., a usable configuration) via at least one fastener 146 such as, but not limited to, a locking fastener. As a result, the sidewalls 140 cannot collapse during use.

The sidewalls 140 may be comprised of various storage structures. In one embodiment, a sidewall 140 is comprised of at least one hook 150 that allows a user to hang a bag, a towel, etc. In another embodiment, a sidewall 140 is also comprised of a rail 152 that a user can clip or hang various items from. The sidewall 140 may also be comprised of at least one pocket 148 for storing various items.

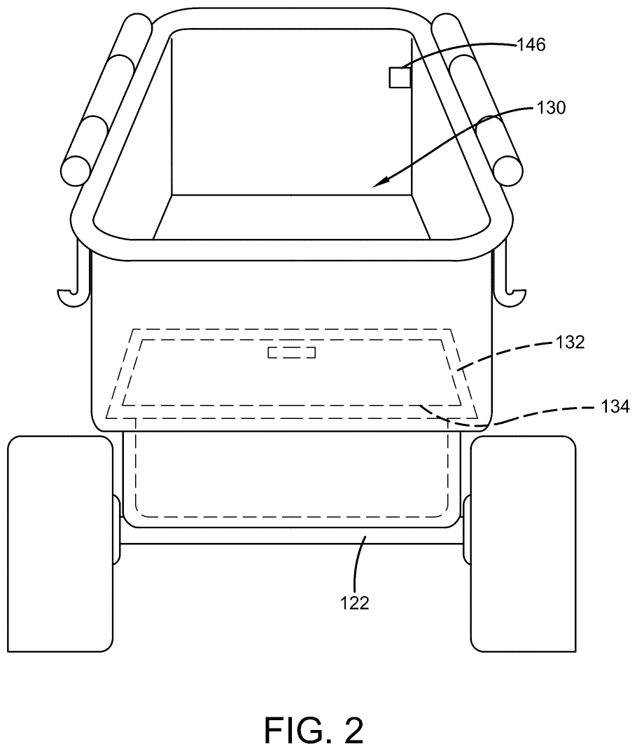

The sidewalls 140 form an interior space 130 of the body 110 that allows items to be stored in the body 110 and be transported by the device 100. In one embodiment, the interior space 130 is comprised of an opening 132 that removably receives at least one insulated cooler 134, as seen in FIG. 2. In a different embodiment, the cooler 134 is fixedly attached within the opening 132 and can be drained via at least one drain plug 136.

The device 100 is self-propelled via at least one motor 160. The motor 160 may be any type of electric motor known in the art with at least one speed. The motor 160 is powered by at least one rechargeable battery 164 of any voltage and configuration known in the art. The battery 164 may be recharged by a charging port 166 such as, but not limited to, a USB port, an 18V charging port, etc.

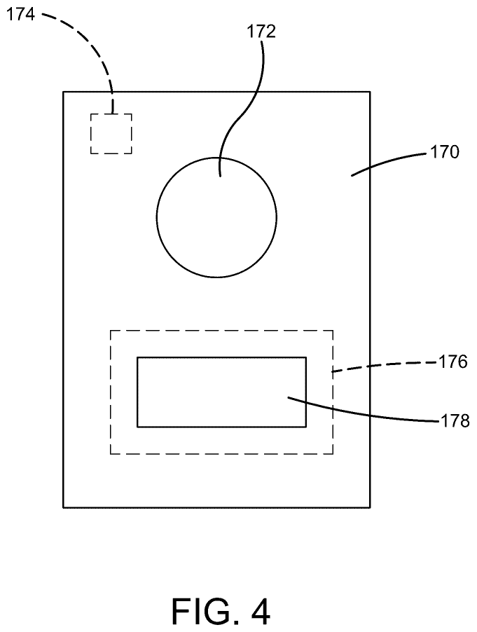

The motor 160 is also comprised of at least one wireless receiver 162. The receiver 162 is in wireless electrical communication with at least one transmitter 174 of at least one remote 170. The remote 170 (as seen in FIG. 4) is used to control the speed, power, and direction of the device 100 using at least one button 172. During use, the motor 160 may turn each axle 122 simultaneously or independently to steer the device 100. The motor 160 may also turn at least one drive shaft 126 connected to each axle 122 to propel each axle 122 and wheel 124. The remote 170 is powered by at least one battery 176. The battery 176 may be a rechargeable battery or may be charged via at least one charging port 178 such as, but not limited to, a USB charging port.

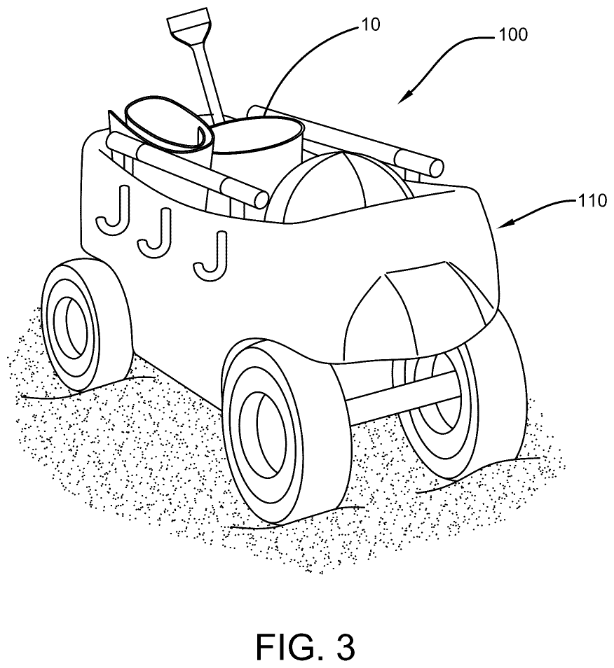

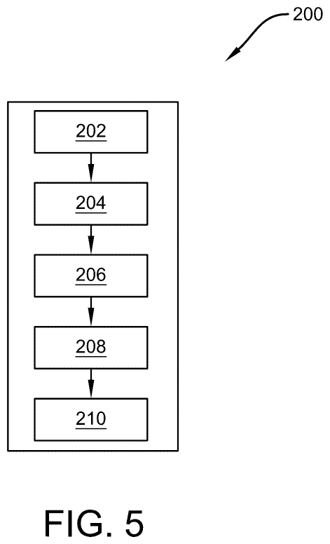

FIG. 5 illustrates a flowchart of a method of using one 200 potential embodiment of a remote-control wagon device 100 of the present invention in accordance with the disclosed architecture. The present invention is also comprised of a method of using the device 100. First, a device 100 is provided, the device 100 is comprised of a body 110 with a frame 120, at least one wheel 124, at least one sidewall 140, at least one motor 160, at least one battery 164, and at least one remote 170 [Step 202]. Then, the device 100 can be transported to an area with the sidewalls 140 folded [Step 204]. Once a user reaches said area, the device 100 can be removed from the transportation vehicle and the walls 140 of the body 110 can be unfolded and secured in an upright configuration using a fastener 146 [Step 206]. Next, items 10 can be placed into the interior space 130 of the body 110, as seen in FIG. 3 [Step 208]. Then, the device 100 can be propelled and steered by the remote 170 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “remote-control wagon device” and “device” are interchangeable and refer to the remote-control wagon device 100 of the present invention.

Notwithstanding the foregoing, the remote-control wagon device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the remote-control wagon device 100 as shown in the FIGS. are for illustrative purposes only, and that many other sizes and shapes of the remote-control wagon device 100 are well within the scope of the present disclosure. Although the dimensions of the remote-control wagon device 100 are important design parameters for user convenience, the remote-control wagon device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A remote-control wagon device comprising:
a frame;
an axle;
a wheel;
a body;
a sidewall attached to the body by a pivot point;
a motor;
a battery;
a receiver; and
a remote comprised of a button and a transmitter.

2. The remote-control wagon device of claim 1, wherein the sidewall is comprised of a waterproof plastic material.

3. The remote-control wagon device of claim 1, wherein the pivot point is comprised of a hinge.

4. The remote-control wagon device of claim 1, wherein the sidewall is configured to rotate 180 degrees around the hinge.

5. The remote-control wagon device of claim 1, wherein the motor is an electric motor.

6. The remote-control wagon device of claim 1, wherein the wheel is an inflatable sand wheel.

7. The remote-control wagon device of claim 1 further comprising a fastener.

8. The remote-control wagon device of claim 1, wherein an interior space of the body is comprised of an insulated cooler comprised of a drain plug.

9. A remote-control wagon device comprising:
a frame;
an axle;
a wheel;
a body;
a sidewall attached to the body by a pivot point, wherein the sidewall is comprised of a hook and a rail;
an interior space having an opening;
a motor;
a battery;
a receiver; and
a remote comprised of a button and a transmitter.

10. The remote-control wagon device of claim 9, wherein an insulated cooler is positioned within the opening.

11. The remote-control wagon device of claim 9, wherein the sidewall is comprised of a waterproof fabric material.

12. The remote-control wagon device of claim 11, wherein the sidewall is comprised of a frame.

13. The remote-control wagon device of claim 9, wherein the pivot point is comprised of a hinge.

14. The remote-control wagon device of claim 9, wherein the receiver is in wireless electrical communication with the transmitter.

15. The remote-control wagon device of claim 9 further comprised of a drive shaft attached to the axle.

16. The remote-control wagon device of claim 15, wherein the motor spins the drive shaft.

17. The remote-control wagon device of claim 9, wherein the motor turns the axle.

18. The remote-control wagon device of claim 9, wherein the sidewall is comprised of a pocket.

19. The remote-control wagon device of claim 9, wherein the battery is comprised of a charging port.

20. A method of using a remote-control wagon device, the method comprising the steps of:
providing a remote-control wagon device comprised of a body, a frame, a wheel, a sidewall, a motor, a battery and a remote;
transporting the remote-control wagon device with the sidewall in a folded configuration;
unfolding the sidewall and securing the sidewall in an upright position;
placing an item into an interior space of the body; and
propelling and steering the remote-control wagon device via the remote.
